(19) United States
(12) Patent Application Publication
(10) Pub. No.: US 2024/0028170 A1
(43) Pub. Date: Jan. 25, 2024

(54) TOUCH DEVICE

(71) Applicant: Innolux Corporation, Miaoli County (TW)

(72) Inventors: Ming-Cheng Hsieh, Miaoli County (TW); Tsan-Po Weng, Miaoli County (TW)

(73) Assignee: Innolux Corporation, Miaoli County (TW)

(21) Appl. No.: 18/337,043

(22) Filed: Jun. 19, 2023

(30) Foreign Application Priority Data
Jul. 22, 2022 (CN) 202210867456.2

(51) Int. Cl. G06F 3/044; G06F 3/041

(52) U.S. Cl. CPC G06F 3/0445; G06F 3/0412

(57) ABSTRACT

A touch device includes a display panel, a conductive layer, and a first touch substrate. The display panel includes a first substrate. The conductive layer is disposed on a first surface of the first substrate. The first touch substrate is disposed on the conductive layer and includes a first touch electrode.

### CROSS-REFERENCE TO RELATED APPLICATION

This application claims the priority benefit of China application serial no. 202210867456.2, filed on Jul. 22, 2022. The entirety of the above-mentioned patent application is hereby incorporated by reference herein and made a part of this specification.

### BACKGROUND

### Technical Field

The disclosure relates to a touch device, and more particularly, to a touch device capable of improving touch signals.

### Description of Related Art

In recent years, touch technology has been integrated into many electronic devices to provide a more convenient and intuitive operation method. However, the current touch technology still faces some problems. For example, when the size of the touch panel increases, the transmission impedance or load of the panel also increases, resulting in insufficient signal charging time.

### SUMMARY

The disclosure provides a touch device, which helps to improve the problem of insufficient signal charging time.

According to an embodiment of the disclosure, a touch device includes a display panel, a conductive layer, and a first touch substrate. The display panel includes a first substrate. The conductive layer is disposed on a first surface of the first substrate. The first touch substrate is disposed on the conductive layer and includes a first touch electrode.

According to another embodiment of the disclosure, a touch device includes a touch element and a control element. The touch element includes a first touch electrode and a second touch electrode. The control element is configured to provide a first signal to the first touch electrode and a second signal to the second touch electrode. The distance between the first touch electrode and the control element is a first distance, and the distance between the second touch electrode and the control element is a second distance. The second distance is greater than the first distance. The width of the second touch electrode is greater than the width of the first touch electrode.

In order to make the above-mentioned features and advantages of the disclosure more comprehensible, embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIGS. 1 and 3 to 7 are partial cross-sectional schematic views of touch devices according to some embodiments of the disclosure, respectively.

FIGS. 2 and 8 are partial top schematic views of touch devices according to some embodiments of the disclosure, respectively.

FIGS. 9A to 9C, 10A to 10C, and 11A to 11C are schematic diagrams of signals provided to different touch electrodes, respectively.

### DESCRIPTION OF THE EMBODIMENTS

Reference is now made in detail to exemplary embodiments of the disclosure, and examples of the exemplary embodiments are illustrated in the accompanying drawings. Wherever possible, the same reference numerals are used in the drawings and descriptions to refer to the same or similar parts.

Throughout the description of the disclosure and the appended claims, certain terms may be used to refer to specific elements. People skilled in the art should understand that electronic device manufacturers may refer to the same elements by different names. The disclosure does not intend to distinguish between elements that have the same function but have different names. In the following description and claims, the words “comprising” and “including” are open-ended words, and thus should be interpreted as meaning “including but not limited to . . . .”

Directional terms referred to herein, such as “up”, “down”, “front”, “rear”, “left”, “right”, etc., merely refer to directions of the accompanying drawings. Therefore, the directional terms are used to illustrate rather than limit the disclosure. In the accompanying drawings, various figures illustrate the general features of methods, structures and/or materials used in the particular embodiments. However, these figures should not be interpreted as defining or limiting the scope or nature covered by these embodiments. For example, the relative sizes, thicknesses, and positions of various layers, regions and/or structures may be reduced or enlarged for clarity.

A structure (layer, element, or substrate) described in the disclosure is located on/over another structure (layer, element, or substrate), which may indicate that the two structures are adjacent to and in a direct connection with each other, or may indicate that the two structures are adjacent to each other but are in an indirect connection with each other. The indirect connection indicates that at least one intermediate structure (intermediate layer, intermediate element, intermediate substrate, or intermediate space) exists between the two structures, the lower surface of one of the structures is adjacent to or directly connected to the upper surface of the intermediate structure, and the upper surface of the other structure is adjacent to or directly connected to the lower surface of the intermediate structure. The intermediate structure may be composed of a single-layer or multi-layer entity structure or a non-entity structure, which is not limited by the disclosure. In the disclosure, when a certain structure is disposed “on” other structures, it may indicate that the certain structure is “directly” on other structures, or it indicates that the certain structure is “indirectly” on other structures, that is, at least one structure is disposed between the certain structure and the other structures.

The terms “about”, “equal to”, “equivalent” or “the same”, “essentially” or “substantially” are generally interpreted as within 20% of a given value or range, or as within 10%, 5%, 3%, 2%, 1%, or 0.5% of a given value or range. Furthermore, the terms “a range is from a first value to a second value”, or “a range between a first value to a second value” indicate that the range includes the first value, the second value, and other values in between.

Ordinal numbers such as “first”, “second”, etc. used in the description and claims are used to modify elements. The ordinal numbers do not imply and represent that the (or these) elements have any previous ordinal numbers, nor do they represent the order of a certain element and another element, or the order of a manufacturing method. The use of these ordinal numbers is only used to clearly distinguish an element with a certain name from another element with the same name. The claims and the description may not use the same terms, whereby a first member in the description may be a second member in the claim.

The electrical connection or coupling described in the disclosure may refer to a direct connection or indirect connection. In the case of the direct connection, the endpoints of elements on two circuits are directly connected to each other or connected to each other by a conductor segment. In the case of the indirect connection, switches, diodes, capacitors, inductors, resistors, other suitable elements, or a combination of the aforementioned elements are provided between the endpoints of the elements on two circuits. However, the disclosure is not limited thereto.

In the disclosure, the measurement methods of thickness, length, and width may be measured by using an optical microscope (OM), and the thickness or width may be measured from cross-sectional images in an electron microscope, but not limited thereto. In addition, any two values or directions used for comparison may have certain errors. Moreover, the terms “equal to”, “equivalent”, “the same”, “essentially”, or “substantially” referred to in the disclosure generally mean within 10% of a given value or range. Furthermore, the terms “a given range is from a first value to a second value”, “a given range falls within a range from a first value to a second value”, or “a given range is between a first value to a second value” indicate that the given range includes the first value, the second value, and other values in between. If a first direction is perpendicular to a second direction, the angle between the first direction and the second direction may be between 80 degrees and 100 degrees; if a first direction is parallel to a second direction, the angle between the first direction and the second direction may be between 0 degrees and 10 degrees.

It should be noted that, in the following embodiments, the features of several different embodiments may be replaced, recombined or used in combination to complete other embodiments without departing from the spirit of the disclosure. As long as the features of the various embodiments do not violate the spirit of the disclosure or conflict with each other, they may be mixed and matched at discretion.

Unless otherwise defined, all terms (including technical and scientific terms) used herein have the same meaning as commonly understood by people skilled in the art to which the disclosure pertains. It is understood that these terms, such as those defined in commonly used dictionaries, should be interpreted as having meanings consistent with the relevant art and the background or context of the disclosure, and should not be interpreted in an idealized or overly formal manner unless otherwise defined in the embodiments of the disclosure.

In the disclosure, the touch device may include a display device, a backlight device, an antenna device, a sensing device, or a splicing device, but is not limited thereto. The touch device may be a bendable or flexible touch device. The touch device may be a self-capacitive or mutual-capacitive touch device. The display device may be a non-self-luminous display device or a self-luminous display device. The electronic device may include, for example, liquid crystals, light emitting diodes, fluorescence, phosphors, quantum dots (QDs), other suitable display mediums, or a combination thereof. The antenna device may be a liquid crystal type antenna device or a non-liquid crystal type antenna device. The sensing device may be a sensing device for sensing capacitance, light, heat or ultrasonic waves, but is not limited thereto. In the disclosure, an electronic device may include electronic elements, and the electronic elements may include passive elements and active elements, such as capacitors, resistors, inductors, diodes, transistors, and the like. The diodes may include light emitting diodes or photodiodes. The light emitting diodes may include, for example, organic light emitting diodes (OLEDs), sub-millimeter light emitting diodes (mini LEDs), micro light emitting diodes (micro LEDs) or quantum dot light emitting diodes (quantum dot LEDs), but are not limited thereto. The splicing device may be, for example, a display splicing device or an antenna splicing device, but is not limited thereto. It should be noted that the electronic device may be any arrangement or combination of the foregoing, but is not limited thereto. In addition, the appearance of the electronic device may be a rectangular, circular, or polygonal shape, a shape with curved edges, or other suitable shapes. The electronic device may have a peripheral system such as a drive system, a control system, a light source system, etc. to support the display device, the antenna device, a wearable device (e.g., including augmented reality or virtual reality), an in-vehicle device (e.g., including a car windshield), or the splicing device.

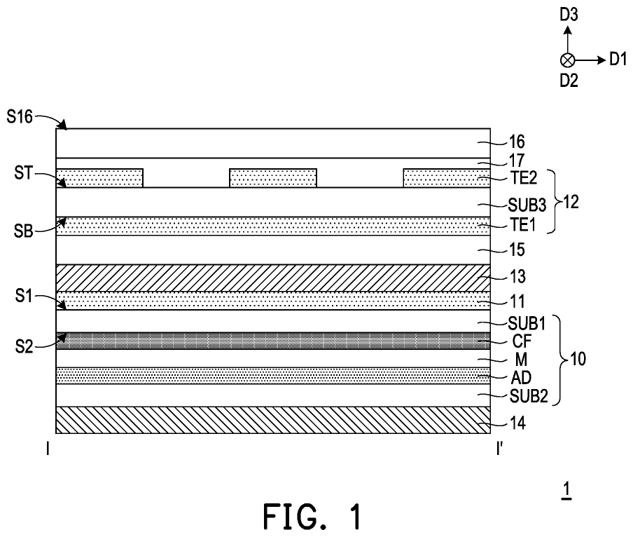

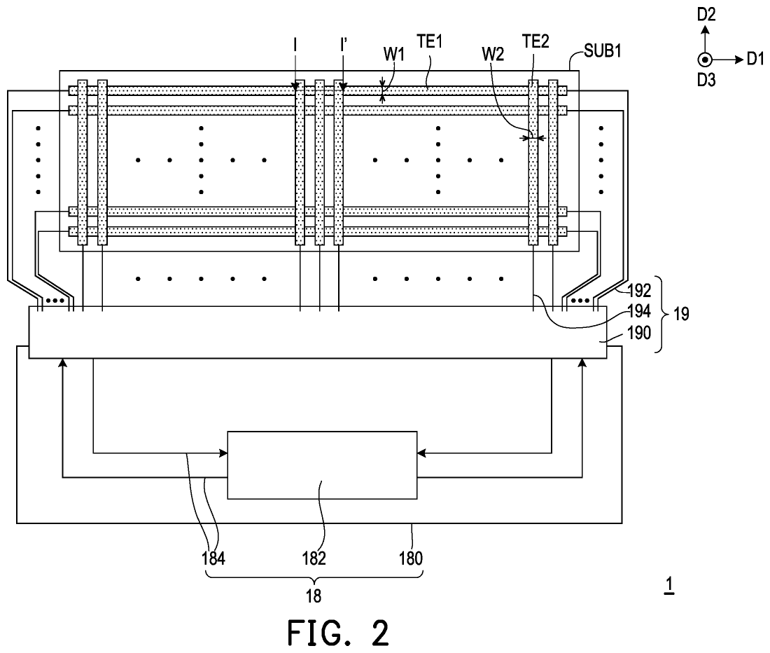

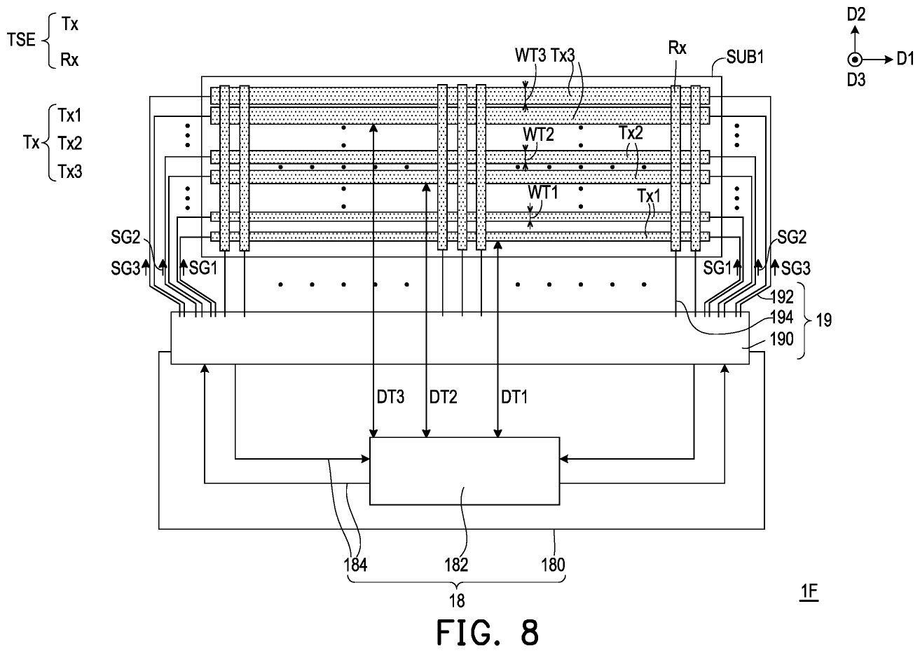

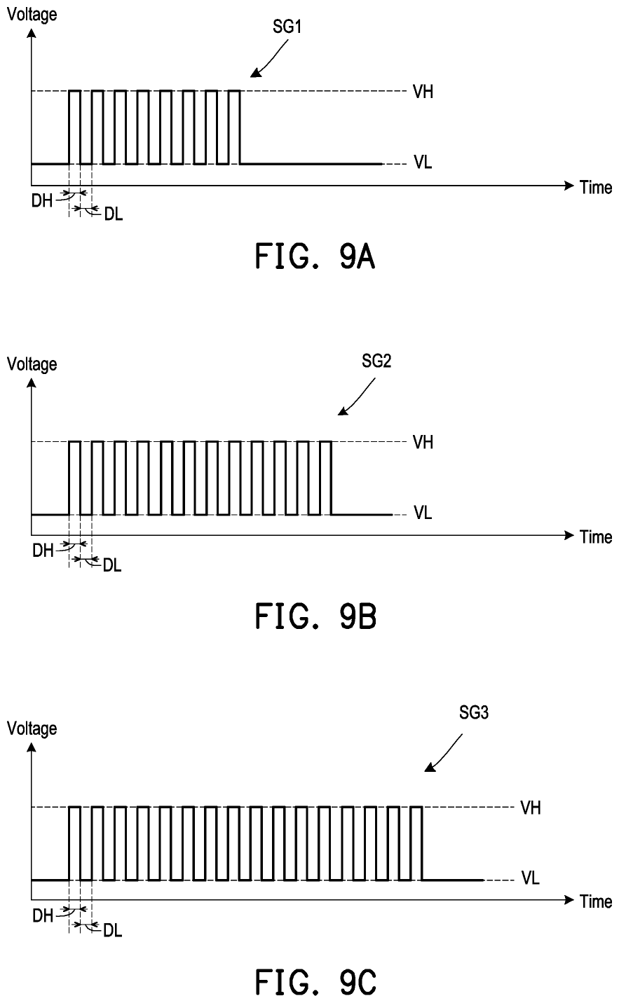

FIGS. 1 and 3 to 7 are partial cross-sectional schematic views of touch devices according to some embodiments of the disclosure, respectively. FIGS. 2 and 8 are partial top schematic views of touch devices according to some embodiments of the disclosure, respectively. FIGS. 9A to 9C, 10A to 10C, and 11A to 11C are schematic diagrams of signals provided to different touch electrodes, respectively. The technical solutions provided in different accompanying drawings may be replaced with each other, combined or used in combination to form another embodiment without departing from the spirit of the disclosure.

FIGS. 1 and 2 are a partial cross-sectional schematic view and a partial top schematic view of a touch device 1 according to an embodiment of the disclosure, respectively. FIG. 1 is, for example, a section corresponding to a line I-I′ in FIG. 2. In FIG. 2, some film layers in the touch device 1 are omitted to clearly show the relative disposition relationship between drive electrodes and sensing electrodes in the touch device 1. Please refer to FIG. 1 for the relative disposition relationship between the omitted film layers and other film layers.

Referring to FIGS. 1 and 2, the touch device 1 may include a display panel 10, a conductive layer 11, and a first touch substrate 12. The display panel 10 includes a substrate SUB1 (e.g., referred to as a first substrate). The conductive layer 11 is disposed on a surface S1 (e.g., referred to as a first surface) of the first substrate. The first touch substrate 12 is disposed on the conductive layer 11 and includes a first touch electrode TE1.

In detail, the display panel 10 is, for example, configured to provide a display function. In addition to the substrate SUB1, the display panel 10 may further include a substrate SUB2, an element array layer AD, a display medium layer M, and a color filter layer CF, but is not limited thereto.

The substrate SUB1 and the substrate SUB2 are disposed opposite to each other, that is, the substrate SUB1 and the substrate SUB2 are disposed to overlap in the thickness direction (e.g., a direction D3) of the display panel 10. The substrate SUB1 and the substrate SUB2 may be rigid substrates or flexible substrates. The materials of the substrate SUB1 and the substrate SUB2 include, for example, glass, quartz, ceramics, sapphire, or plastics, but are not limited thereto. The plastics may include polycarbonate (PC), polyimide (PI), polypropylene (PP), polyethylene terephthalate (PET), other suitable flexible materials or a combination thereof, but are not limited thereto.

The element array layer AD is disposed on the substrate SUB2 and disposed between the substrate SUB1 and the substrate SUB2. Although not shown, the element array layer AD may include multiple signal lines, multiple active elements, multiple electrodes, etc., but is not limited thereto. The signal lines are disposed in a staggered manner. The active elements (such as multiple thin film transistors) are electrically connected to the signal lines and arranged in an array. The electrodes are electrically connected to the active elements.

The display medium layer M is disposed on the element array layer AD and disposed between the element array layer AD and the substrate SUB1. The display medium layer M may include a liquid crystal layer, a light emitting layer, other suitable display mediums, or a combination thereof. Although not shown, when the display medium layer M includes a liquid crystal layer, the touch device 1 may further include a light source module. The light source module is, for example, disposed below the display panel 10 to provide a backlight source for display, but is not limited thereto. For example, when the display panel 10 is a reflective liquid crystal display panel, the touch device 1 may not include a light source module.

As shown in FIG. 1, the color filter layer CF is disposed on the substrate SUB1 and disposed between the substrate SUB1 and the display medium layer M. The substrate SUB1 is provided with the surface S1 (e.g., referred to as the first surface) and a surface S2 (e.g., referred to as a second surface) opposite to the surface S1. The surface S1 is, for example, the surface of the substrate SUB1 facing the first touch substrate 12, and the surface S2 is, for example, the surface of the substrate SUB1 away from the first touch substrate 12. The conductive layer 11 may be disposed on the surface S1 of the substrate SUB1, and the color filter layer CF may be disposed on the surface S2 of the substrate SUB1. In other words, the conductive layer 11 and the color filter layer CF may be respectively disposed on two opposite surfaces of the substrate SUB1, but not limited thereto. Although not shown, the color filter layer CF may be disposed between the element array layer AD and the display medium layer M.

Although not shown, the color filter layer CF may include multiple color filter patterns, such as multiple red filter patterns, multiple green filter patterns, and multiple blue filter patterns, but is not limited thereto. Although not shown, the display panel 10 may further include a black matrix, and the color filter patterns are, for example, respectively disposed in multiple openings of the black matrix.

The conductive layer 11 is disposed between the display panel 10 and the first touch substrate 12. The conductive layer 11 may be an entire conductive layer, and may be configured to reduce or shield the interference of the noise from the display panel 10 to the first touch substrate 12. The conductive layer 11 may be referred to as a signal shielding layer. The conductive layer 11 may be a transparent conductive layer to reduce the shielding of the display light beam. The material of the transparent conductive layer may include metal oxides, such as indium tin oxide, aluminum zinc oxide, indium zinc oxide, etc., or other transparent conductive materials, such as graphene or nano-silver, etc., but is not limited thereto. According to some embodiments, by disposing the conductive layer 11 between the display panel 10 and the first touch substrate 12, the interference of the noise from the display panel 10 to the first touch substrate 12 may be shielded, which helps to improve charging of touch signals in the touch device.

The first touch substrate 12 is, for example, configured to provide a touch function. In addition to the first touch electrode TE1, the first touch substrate 12 may further include a substrate SUB3 (e.g., referred to as a second substrate) and a second touch electrode TE2, but is not limited thereto.

The substrate SUB3 overlaps with the substrate SUB1 and the substrate SUB2 in the thickness direction (e.g., the direction D3) of the touch device 1. The substrate SUB3 may be a rigid substrate or a flexible substrate. The material of the substrate SUB3 includes, for example, glass, quartz, ceramics, sapphire, or plastics, but is not limited thereto.

The first touch electrode TE1 may be disposed on one surface (e.g., a surface SB) of the substrate SUB3, and the second touch electrode TE2 may be disposed on the other surface (e.g., a surface ST) of the substrate SUB3. As shown in FIG. 1, the surface SB and the surface ST may be opposite surfaces of the substrate SUB3. For example, the surface SB is the surface of the substrate SUB3 facing the display panel 10, and the surface ST is the surface of the substrate SUB3 away from the display panel 10. The first touch electrode TE1 may serve as a drive electrode, and the second touch electrode TE2 may serve as a sensing electrode. By making the sensing electrode closer to a touch surface (e.g., a top surface S16 of a cover plate 16) than the drive electrode, the touch sensitivity may be improved. In addition, by separating the first touch electrode TE1 and the second touch electrode TE2 in the direction D3 by the substrate SUB3, the load between the first touch electrode TE1 and the second touch electrode TE2 may be reduced, which helps to improve the problem of insufficient signal charging time. According to other embodiments, the first touch electrode TE1 may serve as a sensing electrode, and the second touch electrode TE2 may serve as a drive electrode.

As shown in FIG. 2, the first touch electrode TE1 and the second touch electrode TE2 may be strip electrodes, but the respective shapes of the first touch electrode TE1 and the second touch electrode TE2 may be changed according to actual needs. The first touch substrate 12 may include multiple first touch electrodes TE1 and multiple second touch electrodes TE2. The first touch electrodes TE1 may extend in a direction D1 and be arranged in a direction D2, and the second touch electrodes TE2 may extend in the direction D2 and be arranged in the direction D1. The direction D1, the direction D2, and the direction D3 may be different. For example, the direction D1 and the direction D2 may both be perpendicular to the direction D3, and the direction D1 may be different from the direction D2. The direction D1 may be perpendicular to the direction D2, but is not limited thereto. Although not shown, the included angle between the direction D1 and the direction D2 may be greater than 0 degrees and less than 90 degrees.

The first touch electrodes TE1 may have the same width (e.g., a width W1), but are not limited thereto. The width W1 may be the width in the direction D2. The second touch electrodes TE2 may have the same width (e.g., a width W2), but are not limited thereto. The width W2 may be the width in the direction D1. The width W2 may be the same or different from the width W1.

Although not shown, a passivation layer may be disposed over the first touch electrodes TE1, and another passivation layer may be disposed over the second touch electrodes TE2 to protect the first touch electrodes TE1 and the second touch electrodes TE2. The materials of the two passivation layers may include inorganic insulating materials, such as silicon oxide or silicon nitride, but are not limited thereto.

According to different requirements, the touch device 1 may further include other elements or film layers. For example, the touch device 1 may further include a polarizer 13, a polarizer 14, an optical adhesive 15, the cover plate 16, an optical adhesive 17, a control module 18, and a connecting member 19, but is not limited thereto.

As shown in FIG. 1, the polarizer 13 may be disposed between the conductive layer 11 and the first touch substrate 12 and may be, for example, disposed on the conductive layer 11. The polarizer 14 is disposed on the surface of the substrate SUB2 away from the element array layer AD. The polarizer 13 and the polarizer 14 may have mutually parallel or mutually perpendicular polarization directions. In some alternative embodiments, for example, when the display panel is an organic light emitting display panel, the touch device 1 may not include the polarizer 14.

The optical adhesive 15 may be disposed between the polarizer 13 and the first touch substrate 12, and the first touch substrate 12 is bonded to the polarizer 13 by, for example, the optical adhesive 15. The material of the optical adhesive 15 may include an optical clear adhesive (OCA) or optical clear resin (OCR), but is not limited thereto.

The cover plate 16 may be disposed on the first touch substrate 12, and the cover plate 16 is bonded to the first touch substrate 12 by, for example, the optical adhesive 17. The material of the cover plate 16 includes, for example, glass, quartz, ceramics, sapphire, or plastics, but is not limited thereto. The material of the optical adhesive 17 may include an OCA or OCR, but is not limited thereto.

As shown in FIG. 2, the control module 18 is electrically connected to the first touch substrate 12 by, for example, the connecting member 19. The control module 18 may output drive signals to the first touch electrodes TE1 and may receive sensing signals from the second touch electrodes TE2 for touch detection. The control module 18 may include a circuit board 180, a control element 182 disposed on the circuit board 180 and electrically connected to the circuit board 180, and multiple wires 184 electrically connecting the connecting member 19 and the control element 182, but is not limited to thereto. The connecting member 19 is, for example, a flexible printed circuit board and may include a carrier board 190, multiple wires 192 electrically connected to the first touch electrodes TE1, and multiple wires 194 electrically connected to the second touch electrodes TE2. The materials of the wires 184, the wires 192, and the wires 194 may include metals, alloys, or other conductive materials.

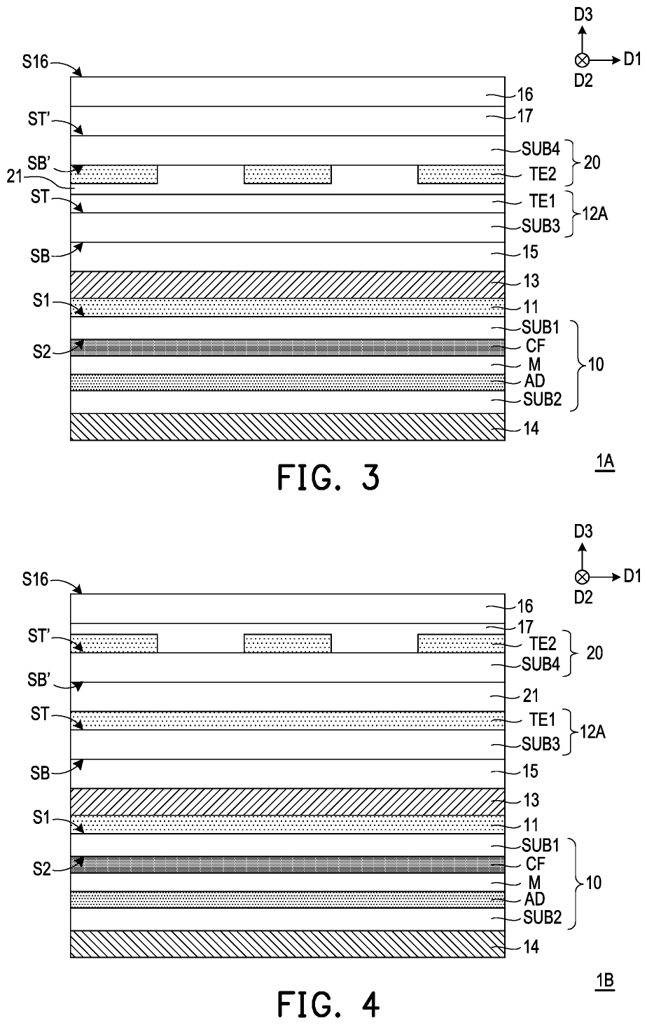

Referring to FIG. 3, the main differences between a touch device 1A and the touch device 1 of FIG. 1 are described below. In a first touch substrate 12A of the touch device 1A, the first touch electrode TE1 is disposed on the surface ST of the substrate SUB3, and the first touch substrate 12A does not include the second touch electrode TE2. In addition, the touch device 1A further includes a second touch substrate 20 and an optical adhesive 21. The second touch substrate 20 is disposed on the first touch substrate 12A and is bonded to the first touch substrate 12A by, for example, the optical adhesive 21, and the cover plate 16 is bonded to the second touch substrate 20 by, for example, the optical adhesive 17. The material of the optical adhesive 21 may include an OCA or OCR, but is not limited thereto.

The second touch substrate 20 may include a substrate SUB4 and the second touch electrode TE2. The substrate SUB4 overlaps with the substrate SUB1, the substrate SUB2, and the substrate SUB3 in the thickness direction (e.g., the direction D3) of the touch device 1A. The substrate SUB4 may be a rigid substrate or a flexible substrate. The material of the substrate SUB4 includes, for example, glass, quartz, ceramics, sapphire, or plastics, but is not limited thereto. The substrate SUB4 has a surface SB′ and a surface ST′ opposite to the surface SB′. The surface SB′ is the surface of the substrate SUB4 facing the first touch substrate 12A, and the surface ST′ is the surface of the substrate SUB4 away from the first touch substrate 12A. The second touch electrode TE2 may be disposed on the surface SB′, and the first touch electrode TE1 may be separated from the second touch electrode TE2 by the optical adhesive 21 in the direction D3, so as to reduce the load between the first touch electrode TE1 and the second touch electrode TE2, which helps to improve the problem of insufficient signal charging time.

Alternatively, as shown in a touch device 1B of FIG. 4, the second touch electrode TE2 may be disposed on the surface ST′, and the first touch electrode TE1 may be separated from the second touch electrode TE2 in the direction D3 by the optical adhesive 21 and the substrate SUB4, so as to reduce the load between the first touch electrode TE1 and the second touch electrode TE2, which helps to improve the problem of insufficient signal charging time.

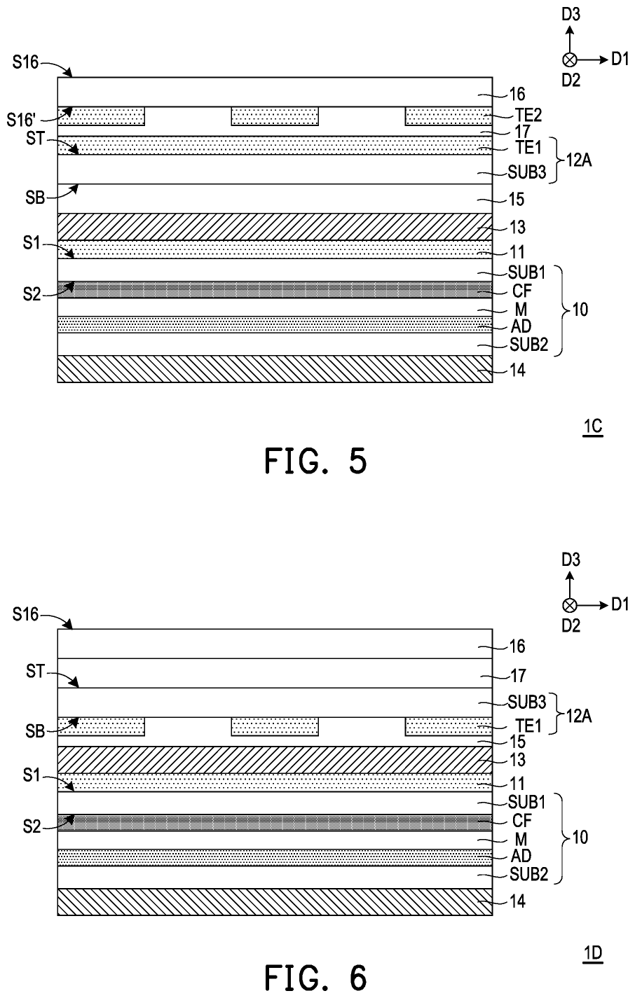

Referring to FIG. 5, the main differences between a touch device 1C and the touch device 1A of FIG. 3 are described below. The touch device 1C may not include the second touch substrate 20, and the touch device 1C further includes the second touch electrode TE2. The second touch electrode TE2 is disposed on the surface of the cover plate 16 facing the first touch substrate 12A (e.g., a bottom surface S16′ of the cover plate 16), and the cover plate 16 and the second touch electrode TE2 are bonded to the first touch substrate 12A by the optical adhesive 17. The first touch electrode TE1 may be separated from the second touch electrode TE2 by the optical adhesive 17 in the direction D3, so as to reduce the load between the first touch electrode TE1 and the second touch electrode TE2, which helps to improve the problem of insufficient signal charging time.

Referring to FIG. 6, the main differences between a touch device 1D and the touch device 1C of FIG. 5 are described below. The touch device 1D may not include the second touch electrode TE2 of FIG. 5. Under the structure of omitting the second touch electrode TE2, the conductive layer 11 is, for example, a patterned electrode layer and serves as a drive electrode, and the first touch electrode TE1, for example, serves as a sensing electrode. In detail, the conductive layer 11 may include multiple strip electrodes or electrodes of other shapes. The arrangement of the strip electrodes of the conductive layer 11 and the first touch electrodes TE1 may be referred to the arrangement of the first touch electrodes TE1 and the second touch electrodes TE2 as shown in FIG. 2, respectively, and thus the descriptions are not repeated here.

Separating the drive electrodes (such as the strip electrodes of the conductive layer 11) and the sensing electrodes (such as the first touch electrodes TE1) in the direction D3 by the polarizer 13 and the optical adhesive 15 may reduce the load between the drive electrodes and the sensing electrodes, which helps to improve the problem of insufficient signal charging time of the first touch electrodes TE1.

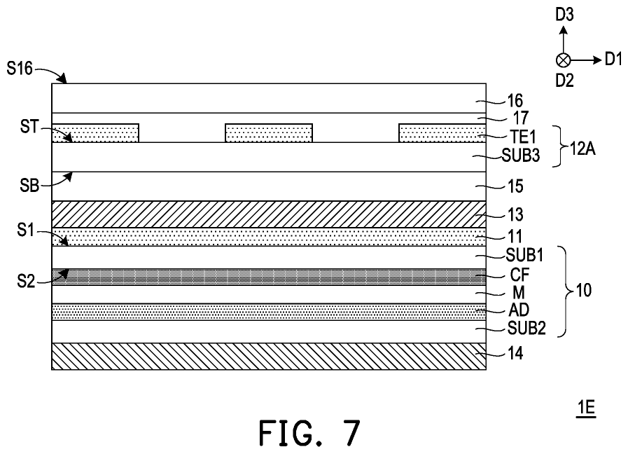

In the touch device 1D, the first touch electrodes TE1 are disposed on the surface SB of the substrate SUB3, but are not limited thereto. As shown in a touch device 1E of FIG. 7, the first touch electrodes TE1 may be disposed on the surface ST of the substrate SUB3.

Referring to FIG. 8, a touch device 1F includes a touch element TSE and the control element 182, but is not limited thereto. According to different requirements, the touch device 1F may further include other elements or film layers, such as a substrate SUB, the connecting member 19, the circuit board 180, the wires 184 and/or the display panel, the polarizers, and the optical adhesives, etc. in the aforementioned cross-sectional schematic views.

The touch element TSE may include multiple drive electrodes Tx and multiple sensing electrodes Rx. The drive electrodes Tx may extend in the direction D1 and are arranged in the direction D2, and the sensing electrodes Rx may extend in the direction D2 and are arranged in the direction D1. The direction D1 and the direction D2 are both perpendicular to the thickness direction (e.g., the direction D3) of the touch device 1E, and the direction D1 is different from the direction D2. The direction D1 may be perpendicular to the direction D2, but is not limited thereto. Although not shown, the included angle between the direction D1 and the direction D2 may be greater than 0 degrees and less than 90 degrees.

The materials of the drive electrodes Tx and the sensing electrodes Rx may include metal oxides, such as indium tin oxide, aluminum zinc oxide, or indium zinc oxide, etc., or other transparent conductive materials, such as graphene or nano-silver, etc., but are not limited thereto.

The control element 182 is disposed on one side of the drive electrodes Tx, and the drive electrodes Tx are arranged, for example, in the direction away from the control element 182 (e.g., the direction D2). The larger the distance between the drive electrode Tx and the control element 182, the longer the transmission path of the signal, and the shorter the charging time of the drive electrode Tx. In the embodiment, the width of the drive electrode Tx may be adjusted according to the distance between the drive electrode Tx and the control element 182. For example, the larger the distance, the larger the width, thereby improving the problem of insufficient signal charging time. Taking FIG. 8 as an example, the drive electrodes Tx may be divided into three parts, but are not limited thereto. In other embodiments, the drive electrodes Tx may be divided into two parts or more parts, and each of the parts includes one or more drive electrodes Tx.

For the convenience of description, the three parts are hereinafter referred to as the first part, the second part, and the third part. The first part is closest to the control element 182 and the third part is farthest from the control element 182. The touch element TSE may include the drive electrodes Tx, and the drive electrodes Tx include a first touch electrode Tx1, located in the first part; and a second touch electrode Tx2, located in the second part. The distance between the first touch electrode Tx1 and the control element 182 in the first part (e.g., the distance between the first touch electrode Tx1 closest to the control element 182 and the control element 182) may be referred to as a first distance DT1 for the convenience of description. In addition, the first touch electrode Tx1 has a first width (such as a width WT1). The distance between the second touch electrode Tx2 and the control element 182 in the second part (e.g., the distance between the second touch electrode Tx2 closest to the control element 182 and the control element 182) is referred to as a second distance DT2 for the convenience of description. The second distance DT2 is greater than the first distance DT1. In addition, the second touch electrode Tx2 has a second width (such as a width WT2). In some embodiments, the drive electrodes Tx further include a third touch electrode Tx3, located in the third part. The distance between the third touch electrode Tx3 and the control element 182 in the third part (e.g., the distance between the third touch electrode Tx3 closest to the control element 182 and the control element 182) may be referred to as a third distance DT3 for the convenience of description. The third distance DT3 is greater than the second distance DT2. In addition, the third touch electrode Tx3 has a third width (such as a width WT3). The width WT1, the width WT2, and the width WT3 may be widths in the same direction. In detail, the extending direction of the first touch electrode Tx1, the second touch electrode Tx2, and the third touch electrode Tx3 may be the direction D1, the width WT1, the width WT2, and the width WT3 may be the widths in the direction D2, and the direction D1 and the direction D2 may be vertical.

The control element 182 is configured to provide a first signal SG1 to the first touch electrode Tx1, a second signal SG2 to the second touch electrode Tx2, and a third signal SG3 to the third touch electrode Tx3. Since the third distance DT3 is greater than the second distance DT2, and the second distance DT2 is greater than the first distance DT1, compared with the second touch electrode Tx2, the third touch electrode Tx3 needs a longer time to receive the drive signal. Similarly, compared with the first touch electrode Tx1, the second touch electrode Tx2 needs a longer time to receive the drive signal. Therefore, the charging time of the third touch electrode Tx3 is shorter than the charging time of the second touch electrode Tx2, and the charging time of the second touch electrode Tx2 is shorter than the charging time of the first touch electrode Tx1. According to some embodiments, the design of making the width WT2 of the second touch electrode Tx2 larger than the width WT1 of the first touch electrode Tx1 may increase the amount of signal transmission per unit time, thereby helping to improve the problem of insufficient signal charging time. Similarly, according to some embodiments, the width WT3 of the third touch electrode Tx3 may be made larger than the width WT2 of the second touch electrode Tx2, and a similar effect may also be achieved. In some embodiments, the width WT2 may be N times the width WT1, and the width WT3 may be M times the width WT2. M and N are, for example, greater than 1 and less than or equal to 1.05, but are not limited thereto. According to some embodiments, M and N may be, for example, greater than 1 and less than or equal to 1.02, greater than 1 and less than or equal to 1.03, greater than 1 and less than or equal to 1.07, and greater than 1 and less than or equal to 1.2, but are not limited thereto. Furthermore, M may be the same or different from N. In some embodiments, an algorithm or software may be configured to correct the displayed image to improve the problem of discontinuity of the displayed image due to the different widths of the drive electrodes Tx.

As mentioned above, in some embodiments, different touch electrodes may have different widths according to different distances from the control element 182. In detail, the distance between the first touch electrode Tx1 and the control element 182 is DT1, the distance between the second touch electrode Tx2 and the control element 182 is DT2, the width of the first touch electrode Tx1 may be designed as WT1, and the second width of the second touch electrode Tx2 may be designed as WT2. In this way, the problem of insufficient signal charging time may be improved. In some embodiments, the problem of insufficient signal charging time may further be improved by changing the design parameters (such as at least one of voltage, time, and quantity) of the touch signal (to be described later).

It should be understood that although FIG. 8 shows that each signal is provided to the drive electrode Tx from opposite ends of the drive electrode Tx, the disclosure does not exclude that each signal is provided to the drive electrode Tx from a single side of the drive electrode Tx.

In some embodiments, the signals (such as the first signal SG1, the second signal SG2, and the third signal SG3) provided to different touch electrodes (such as the first touch electrode Tx1, the second touch electrode Tx2, and the third touch electrode Tx3) may be changed to improve the problem of insufficient signal charging time.

According to some embodiments, the touch element TSE may be disposed in the aforementioned first touch substrate 12 and/or the second touch substrate 20. According to some embodiments, the touch element TSE may be disposed in the aforementioned first touch substrate 12/or the second touch substrate 20, and combined with the display panel to form an out-cell touch display device. According to some embodiments, the touch element TSE may be disposed in the aforementioned display panel 10 to form an in-cell touch display device.

Referring to FIGS. 9A to 9C, 10A to 10C, and 11A to 11C, the first signal SG1 may be a first pulse signal, the second signal SG2 may be a second pulse signal, and the third signal SG3 may be a third pulse signal. According to some embodiments, the first pulse signal and the second pulse signal may be different. According to some embodiments, the first pulse signal SG1, the second pulse signal SG2, and the third pulse signal SG3 may be different.

For example, as shown in FIGS. 9A to 9C, the first pulse signal, the second pulse signal, and the third pulse signal may have the same voltage (e.g., the same low electric potential VL and the same high electric potential VH) and the same time (e.g., in each of the pulse signals, a duration DH of the high electric potential VH may be the same and a duration DL of the low electric potential VL may be the same). Moreover, the number of the second pulse signals may be greater than the number of the first pulse signals, and the number of the third pulse signals may be greater than the number of the second pulse signals. FIG. 9A schematically shows that the number of the first pulse signals provided to each of the first touch electrodes Tx1 (shown in FIG. 8) is eight. FIG. 9B schematically shows that the number of the second pulse signals provided to each of the second touch electrodes Tx2 (shown in FIG. 8) is 12. FIG. 9C schematically shows that the number of the third pulse signals provided to each of the third touch electrodes Tx3 (shown in FIG. 8) is 16. However, it should be understood that the above numbers are only examples, and the number of each of the pulse signals may be changed according to actual needs.

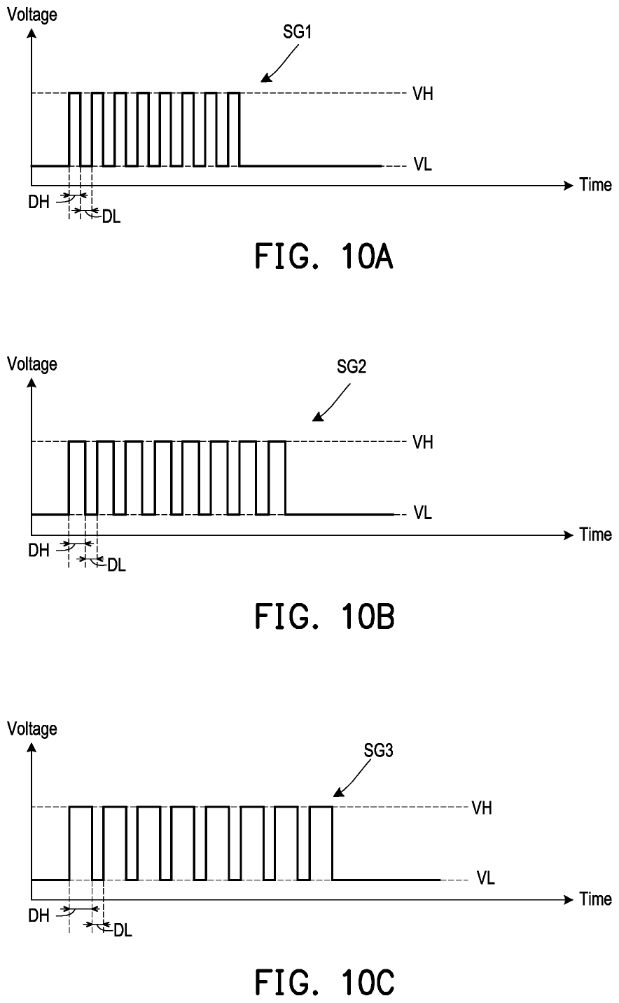

Alternatively, as shown in FIGS. 10A to 10C, the first pulse signal, the second pulse signal, and the third pulse signal may have the same voltage (e.g., the same low electric potential VL and the same high electric potential VH) and the same numbers. Moreover, the time of the second pulse signal may be greater than the time of the first pulse signal, and the time of the third pulse signal may be greater than the time of the second pulse signal. For example, the duration DH of the high electric potential VH in the second pulse signal may be greater than the duration DH of the high electric potential VH in the first pulse signal, the duration DH of the high electric potential VH in the third pulse signal may be greater than the duration DH of the high electric potential VH in the second pulse signal, and the duration DL of the low electric potential VL in each of the pulse signals may be the same, but not limited thereto.

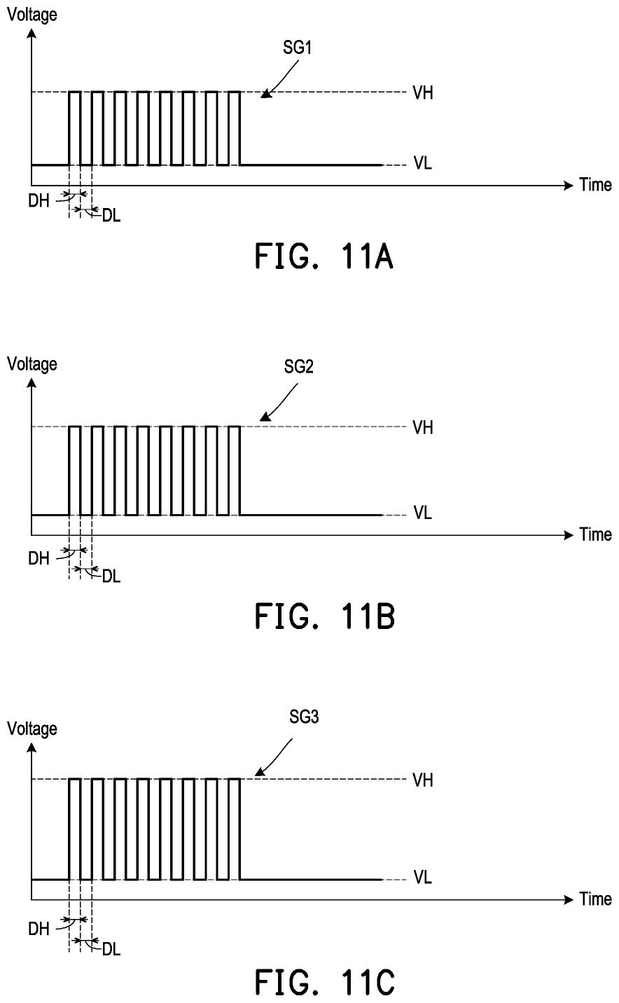

Furthermore, as shown in FIGS. 11A to 11C, the first pulse signal, the second pulse signal, and the third pulse signal may have the same time and the same numbers. Moreover, the voltage of the second pulse signal may be greater than the voltage of the first pulse signal, and the voltage of the third pulse signal may be greater than the voltage of the second pulse signal. For example, the high electric potential VH in the second pulse signal may be greater than the high electric potential VH in the first pulse signal, the high electric potential VH in the third pulse signal may be greater than the high electric potential VH in the second pulse signal, and the low electric potential VL in each of the pulse signals may be the same, but not limited thereto.

To sum up, in some embodiments of the disclosure, disposing the conductive layer between the display panel and the touch substrate may shield the interference of the noise from the display panel to the touch substrate, which helps to improve charging of the touch signals in the touch device. In some embodiments, different touch electrodes may have different widths according to different distances from the control element, thereby improving the problem of insufficient signal charging time. In some embodiments, the problem of insufficient signal charging time may further be improved by changing the design parameters (such as at least one of voltage, time, and quantity) of the touch signal.

The above embodiments are only used to illustrate the technical solutions of the disclosure, but not to limit the technical solutions of the disclosure. Although the disclosure has been described in detail with reference to the foregoing embodiments, those of ordinary skill in the art should understand that the technical solutions described in the foregoing embodiments may still be modified, or some or all of the technical features thereof may be equivalently replaced. However, these modifications or substitutions do not make the essence of the corresponding technical solutions deviate from the scope of the technical solutions of the embodiments of the disclosure.

Although the embodiments of the disclosure and the advantages of the embodiments have been disclosed above, it should be understood that any person of ordinary skill in the art may make changes, substitutions, and modifications without departing from the spirit and scope of the disclosure. Moreover, the features of the various embodiments may be mixed and replaced with each other at discretion to form other new embodiments. In addition, the protection scope of the disclosure is not limited to the processes, machines, manufacture, compositions of matter, devices, methods, and steps in the specific embodiments described in the specification. Any person of ordinary skill in the art may understand the present or future developed processes, machines, manufacture, compositions of matter, devices, methods, and steps from the disclosure, which may be used based on the disclosure as long as they can perform substantially the same functions or achieve substantially the same results in the embodiments described herein. Therefore, the protection scope of the disclosure includes the above-mentioned processes, machines, manufacture, compositions of matter, devices, methods, and steps. In addition, each claim constitutes a separate embodiment, and the protection scope of the disclosure also includes combinations of each claim and the embodiment. The scope of protection of the disclosure shall be defined by the appended claims.

What is claimed is:

1. A touch device, comprising:
a display panel, comprising a first substrate;
a conductive layer, disposed on a first surface of the first substrate; and
a first touch substrate, disposed on the conductive layer and comprising a first touch electrode.

2. The touch device according to claim 1, wherein the first touch substrate comprises:
a second substrate; and
a second touch electrode, wherein the first touch electrode is disposed on one surface of the second substrate, and the second touch electrode is disposed on the other surface of the second substrate.

3. The touch device according to claim 1, further comprising:
a second touch substrate, disposed on the first touch substrate and comprising a second touch electrode.

4. The touch device according to claim 3, further comprising:
an optical adhesive, disposed between the second touch substrate and the first touch substrate.

5. The touch device according to claim 1, further comprising:
a polarizer, disposed between the conductive layer and the first touch substrate.

6. The touch device according to claim 5, further comprising:
an optical adhesive, disposed between the polarizer and the first touch substrate.

7. The touch device according to claim 1, wherein the conductive layer is a patterned electrode layer.

8. The touch device according to claim 7, wherein the conductive layer serves as a drive electrode, and the first touch electrode serves as a sensing electrode.

9. The touch device according to claim 1, wherein the conductive layer is a transparent conductive layer.

10. A touch device, comprising:
a touch element, comprising a first touch electrode and a second touch electrode; and
a control element, configured to provide a first signal to the first touch electrode and a second signal to the second touch electrode,
wherein a distance between the first touch electrode and the control element is a first distance, a distance between the second touch electrode and the control element is a second distance, and the second distance is greater than the first distance,
wherein a width of the second touch electrode is greater than a width of the first touch electrode.

11. The touch device according to claim 10, wherein the first signal is a first pulse signal, the second signal is a second pulse signal, and the first pulse signal and the second pulse signal are different.

12. The touch device according to claim 11, wherein time of the second pulse signal is longer than time of the first pulse signal.

13. The touch device according to claim 12, wherein a number of the second pulse signals is equal to a number of the first pulse signals, and a voltage of the second pulse signal is equal to a voltage of the first pulse signal.

14. The touch device according to claim 11, wherein a number of the second pulse signals is greater than a number of the first pulse signals.

15. The touch device according to claim 14, wherein time of the second pulse signal is equal to time of the first pulse signal, and a voltage of the second pulse signal is equal to a voltage of the first pulse signal.

16. The touch device according to claim 11, wherein a voltage of the second pulse signal is greater than a voltage of the first pulse signal.

17. The touch device according to claim 16, wherein time of the second pulse signal is equal to time of the first pulse signal, and a number of the second pulse signals is equal to a number of the first pulse signals.

18. The touch device according to claim 10, further comprising:
a display panel, and the touch element is disposed outside the display panel to form an out-cell touch display device.

19. The touch device according to claim 10, further comprising:
a display panel, and the touch element is disposed in the display panel to form an in-cell touch display device.

20. The touch device according to claim 10, wherein the first touch electrode and the second touch electrode are touch electrodes of the same layer.
